(19) United States
(12) Patent Application Publication
(10) Pub. No.: US 2022/0363587 A1
(43) Pub. Date: Nov. 17, 2022

(54) GLASS SUBSTRATE, DISPLAY DEVICE, AND METHOD FOR MANUFACTURING GLASS SUBSTRATE

(71) Applicant: AGC Inc., Tokyo (JP)

(72) Inventors: Takayuki KAKEGAWA, Tokyo (JP); Yuki AKAMA, Tokyo (JP); Satoru TOMENO, Tokyo (JP)

(73) Assignee: AGC Inc., Tokyo (JP)

(21) Appl. No.: 17/877,464

(22) Filed: Jul. 29, 2022

Related U.S. Application Data
(63) Continuation of application No. PCT/JP2021/002345, filed on Jan. 22, 2021.

(30) Foreign Application Priority Data
Jan. 30, 2020 (JP) 2020-013695

(51) Int. Cl. C03C 3/095; C03C 3/085; C03C 3/087; C03C 3/091; C03C 3/078; C03C 4/00; C03C 15/00; C03C 23/00

(52) U.S. Cl. CPC C03C 3/095; C03C 3/085; C03C 3/087; C03C 3/091; C03C 3/078; C03C 4/0071; C03C 15/00; C03C 23/0025; C03C 2204/08

(57) ABSTRACT

The present invention relates to a glass substrate, having a specific matrix composition and including an etched surface having the number of protrusions of 400 or more and 2,000 or less on at least one of main surfaces, in which the number of protrusions is obtained by measuring a region of 285.12 μm×213.77 μm with a laser microscope to obtain XYZ data of a surface shape, and conducting a shape analysis of the XYZ data by using an image processing software SPIP manufactured by Image Metrology.

### CROSS-REFERENCE TO RELATED APPLICATIONS

This is a continuation of International Application No. PCT/JP2021/002345 filed on Jan. 22, 2021, and claims priority from Japanese Patent Application No. 2020-013695 filed on Jan. 30, 2020, the entire content of which is incorporated herein by reference.

### TECHNICAL FIELD

The present invention relates to a glass substrate that is used in a display device and the like, and has reduced glare and excellent washability, to a display device equipped with the glass substrate, and to a method for manufacturing the glass substrate.

### BACKGROUND ART

In recent years, for example, a cover constituted of a glass is arranged on a display surface side of a display device such as a liquid crystal display (LCD) device in order to protect the display device.

However, in the case where such a glass plate is arranged on a display device, when visually observing the display device through the glass plate, reflection of an object placed around the glass plate (ambient reflection) may sometimes occur on the glass plate. When the ambient reflection occurs on the glass plate, a viewer of display image is difficult to visually recognize the display image and comes to receive unpleasant impression.

To suppress such ambient reflection, an attempt is made to apply an antiglare treatment of forming concavo-convex shape to the surface of the glass plate. Examples of the method for the antiglare treatment include a method of etching the surface of a glass plate (e.g., see Patent Document 1) and a method of forming a film having concavo-convex shape on the surface of the glass plate (e.g., see Patent Document 2).

On the other hand, in such a display device, the surface of a glass substrate constituting a cover is sometimes touched by human fingers and the like, and when the human fingers touch the surface, sebum and the like easily adheres to the surface of the glass plate. When sebum and the like adheres to the surface, visibility is affected. For this reason, the glass substrate where the antiglare-treated surface is further subjected to an antifouling treatment has conventionally been used.
Patent document 1: WO2014/119453
Patent document 2: U.S. Pat. No. 8,003,194

### SUMMARY OF INVENTION

The antiglare treatment can suppress the ambient reflection as described above, reduce a reflection and achieve an antifouling effect, and at the same time, may cause demerits such that glare occurs and washing resistance is deteriorated. When the glare occurs on the glass substrate, a viewer of display image is difficult to visually recognize the display image and comes to receive unpleasant impression.

The glare is remarkable in the case where the roughness of the antiglare-treated surface of the glass substrate is larger than pitch between pixels of a display device, in the case where concavo-convex sizes on the surface of the glass substrate are nonuniform, in the case where concavo-convex depths are nonuniform, and the like. Recently, pixel size and pixel pitch are getting smaller with high definition of a display device. Therefore, the problem on glare of the glass substrate is expected to be further remarkable in future. Furthermore, as described above, there is the problem in the display device that sebum and the like are easy to be adhered to the surface of the glass substrate, and washability of sebum and the like is liable to be deteriorated by applying antiglare treatment to the surface.

Accordingly, an object of the present invention is to provide a glass substrate including an etched surface having reduced glare and excellent washability.

Regarding the above problems, the present inventors have found that a glass substrate including an etched surface having reduced glare and excellent washability can be obtained by subjecting a glass having a specific composition to an etching treatment, and have completed the present invention.

The gist of the present invention is as follows.

1. A glass substrate,

having a matrix composition containing, in molar percentage on an oxide basis:
SiO₂: 50 to 75%,
Al₂O₃: 0.1 to 25%,
B₂O₃: 0 to 10%,
Y₂O₃: 0 to 5%,
MgO: 0 to 20%,
CaO: 0 to 15%,
Li₂O: 0 to 15%,
Na₂O: 1 to 25%,
K₂O: 0.1 to 20%,
TiO₂: 0 to 1%, and
ZrO₂: 0 to 2%, and

including an etched surface having the number of protrusions obtained by the following method of 400 or more and 2,000 or less on at least one of main surfaces:

method: a region of 285.12 μm×213.77 μm is measured with a laser microscope to obtain XYZ data of a surface shape, and in a shape analysis of the XYZ data using an image processing software SPIP manufactured by Image Metrology, after leveling the entire surface, the number of protrusions when a threshold level of quantum detection is set to 50.0000 nm is obtained.

2. The glass substrate described in item 1 above, in which the etched surface has a value of concavo-convex mean period RSm of 30 or less.

3. The glass substrate described in item 1 or 2 above, in which the etched surface has an arithmetic average inclination angle RAa of 1.50 or more under the condition of no cut-off value.

4. The glass substrate described in any one of items 1 to 3 above, in which the etched surface has a haze rate of transmitted light of 0.2 to 75% as measured by the method in accordance with JIS K7136 (2000).

5. The glass substrate described in any one of items 1 to 4 above, in which the etched surface has a glare Sₐ of 8 or less as quantified by the following method:

method: the glass substrate is placed on a display surface of a display device having a definition of 264 ppi such that the etched surface is into contact with the display surface, and in a state where an image of single green constituted of RGB (0, 255, 0) is displayed on the display device, a Sparkle value is obtained by an image analysis using SMS-1000 manufactured by DM&S arranged above the glass substrate and denoted as the glare Sₐ, in which a distance d between a fixed image sensor and the glass substrate is set to 568 mm, a camera lens used is 23FM50SP lens having a focal length of 50 mm, and lens aperture is 16, and in which the measurement is conducted by a difference image method (DIM), 0 is input as a pixel ratio value, and the glare Sₐ is obtained.

6. The glass substrate described in any one of items 1 to 5 above, in which the matrix composition satisfies that the total content of Na₂O, K₂O and Li₂O is less than 30% in molar percentage on an oxide basis.

7. A display device including the glass substrate described in any one of items 1 to 6 above.

8. A method for producing a glass substrate including an etched surface having the number of protrusions obtained by the following method of 400 or more and 2,000 or less on at least one of the main surfaces, the method including a step of subjecting a glass substrate containing, in molar percentage on an oxide basis:
SiO₂: 50 to 75%,
Al₂O₃: 0.1 to 25%,
B₂O₃: 0 to 10%,
Y₂O₃: 0 to 5%,
MgO: 0 to 20%,
CaO: 0 to 15%,
Li₂O: 0 to 15%,
Na₂O: 1 to 25%,
K₂O: 0.1 to 20%,
TiO₂: 0 to 1%, and
ZrO₂: 0 to 2%;
   to a frost treatment:

method: a region of 285.12 μm×213.77 μm is measured with a laser microscope to obtain XYZ data of a surface shape, and in a shape analysis of the XYZ data using an image processing software SPIP manufactured by Image Metrology, after leveling the entire surface, the number of protrusions when a threshold level of quantum detection is set to 50.0000 nm is obtained.

The glass substrate according to the embodiment of the present invention effectively suppresses glare and shows excellent washability since the matrix composition of the glass is a composition of specific ranges and the glass has surface characteristics in specific ranges.

### BRIEF DESCRIPTION OF DRAWINGS

FIG. 1 is a view schematically illustrating one example of a measurement apparatus that is used in measuring a glare Sₐ.

FIG. 2 is a view schematically illustrating one example of a measurement apparatus that is used in measuring a reflection image diffusiveness index value R.

### DESCRIPTION OF EMBODIMENTS

The embodiment for carrying out the present invention is hereinafter described, but the present invention is not limited to the following embodiments, and various modifications and substitutions can be added to the embodiments described hereinafter without deviating the scope of the present invention.

<Matrix Composition of Glass>

The composition of the glass can be simply obtained by semi-quantitative analysis according to fluorescent X-ray analysis, and more precisely, can be measured by wet analysis such as ICP emission analysis. Unless otherwise indicated, the content of each component is expressed in molar percentage on an oxide basis.

The glass substrate according to the embodiment of the present invention has a matrix composition containing, in molar percentage on an oxide basis:
SiO₂: 50 to 75%,
Al₂O₃: 0.1 to 25%,
B₂O₃: 0 to 10%,
Y₂O₃: 0 to 5%,
MgO: 0 to 20%,
CaO: 0 to 15%,
Li₂O: 0 to 15%,
Na₂O: 1 to 25%,
K₂O: 0.1 to 20%,
TiO₂: 0 to 1%, and
ZrO₂: 0 to 2%.

SiO₂ is a component constituting a glass framework. Furthermore, SiO₂ is a component enhancing chemical durability and is a component reducing the generation of cracks when the glass is scratched (gets indentation).

The content of SiO₂ in the glass substrate of the present embodiment is 50% or more. The preferable content of SiO₂ is stepwisely 54% or more, 58% or more, 60% or more, 63% or more, 66% or more, and 68% or more.

On the other hand, in the case where the content of SiO₂ exceeds 75%, meltability is remarkably deteriorated. For this reason, the content of SiO₂ in the glass substrate of the present embodiment is 75% or less, preferably 74% or less, more preferably 73% or less, still more preferably 72% or less, particularly preferably 71% or less, and most preferably 70% or less.

Since the glass substrate of the present embodiment contains Al₂O₃, the number of protrusions on the etched surface can be increased to suppresses glare and washability can be improved. From the standpoint of the improvement of characteristics of the etched surface, such as the increase of the number of protrusions, the content of Al₂O₃ is 0.1% or more, and preferably is stepwisely 0.3% or more, 0.5% or more, 0.7% or more, 0.8% or more, 0.9% or more, 1% or more, and 5% or more.

On the other hand, in the case where the content of Al₂O₃ exceeds 25%, acid resistance of the glass is deteriorated or devitrification temperature is increased. Furthermore, the viscosity of the glass is increased and meltability is deteriorated. For this reason, the content of Al₂O₃ in the glass substrate of the present embodiment is 25% or less, preferably 20% or less, more preferably 18% or less, still more preferably 16% or less, and particularly preferably 14% or less.

Y₂O₃ is a component improving crushability of a chemically strengthened glass, and may be contained. In the case where Y₂O₃ is contained in the glass substrate of the present embodiment, the content is preferably 0.5% or more, more preferably 1% or more, still more preferably 1.5% or more, particularly preferably 2% or more, and most preferably 2.5% or more.

In the case where the content of Y₂O₃ exceeds 5%, the glass is easily devitrified when melting, and glass quality may be deteriorated. For this reason, the content of Y₂O₃ in the glass substrate of the present embodiment is 5% or less, preferably 4% or less and more preferably 3% or less.

MgO is a component increasing surface compressive stress of a chemically strengthened glass when chemically strengthening, and is a component improving crushability. Therefore, MgO may be contained. In the case where MgO is contained in the glass substrate of the present embodiment, the content is preferably 3% or more, and more preferably stepwisely 4% or more, 5% or more, 6% or more, 7% or more, and 8% or more.

On the other hand, in the case where the content of MgO exceeds 20%, the glass is easy to be devitrified when melting. For this reason, the content of MgO in the glass substrate of the present embodiment is 20% or less, preferably 15% or less, and more preferably stepwisely 14% or less, 13% or less, 12% or less, 11% or less, and 10% or less.

CaO is a component improving meltability of the glass, is a component improving crushability of the chemically strengthened glass when chemically strengthening. Therefore, CaO may be contained. In the case where CaO is contained in the glass substrate of the present embodiment, the content is preferably 0.5% or more, more preferably 1% or more, still more preferably 2% or more, particularly preferably 3% or more, and most preferably 5% or more.

On the other hand, in the case where the content of CaO exceeds 15%, ion exchange performance is deteriorated. For this reason, the content of CaO in the glass substrate of the present embodiment is 15% or less. The content of CaO is preferably 10% or less, more preferably 9% or less and still more preferably 8% or less.

Li₂O is a component forming surface compressive stress by ion exchange, and is a component improving crushability of the chemically strengthened glass. In the case of conducting a chemically strengthening treatment to exchange Li ions on the glass surface to Na ions, the content of Li₂O in the glass substrate of the present embodiment is preferably 3% or more, more preferably 4% or more, still more preferably 5% or more, particularly preferably 6% or more, and typically 7% or more.

On the other hand, in the case where the content of Li₂O exceeds 15%, acid resistance of the glass is remarkably deteriorated. The content of Li₂O is 15% or less, preferably 14% or less, more preferably 13% or less, still more preferably 12% or less, and particularly preferably 11% or less.

In the case of conducting a chemically strengthening treatment to exchange Na ions on the glass surface to K ions, in the case where the content of Li₂O in the glass substrate of the present embodiment exceeds 3%, compressive stress is sometimes decreased. In this case, the content of Li₂O is preferably 3% or less, more preferably 2% or less, still more preferably 1% or less, and particularly preferably 0.5% or less, and most preferably Li₂O is not substantially contained.

In the present description, the term “is not substantially contained” means that it is not contained other than that contained as an unavoidable impurity contained in raw materials and the like; in other words, it is not intentionally contained. Specifically, the term means that the content in the glass composition is less than 0.1 mol %.

Inclusion of Na₂O can increase the number of protrusions on the etched surface, suppress glare and improve washability. Furthermore, Na₂O is a component improving meltability of the glass, and forms a surface compressive stress layer when ion-exchanged.

From the standpoint of the improvement in characteristics of the etched surface, such as the increase of the number of protrusions, the content of Na₂O in the glass substrate of the present embodiment is 1% or more, preferably 2% or more and more preferably 3% or more.

On the other hand, in the case where the content of Na₂O in the glass substrate of the present embodiment exceeds 25%, acid resistance of the glass is remarkably deteriorated. From the standpoint of acid resistance, the content of Na₂O is 25% or less, preferably 20% or less, more preferably 18% or less, still more preferably 16% or less, and particularly preferably 14% or less.

The inclusion of K₂O can increase the number of protrusions on the etched surface, suppress glare and improve washability. Furthermore, the inclusion of K₂O can improve ion-exchange performance.

From the standpoint of the improvement in characteristics of the etched surface, such as the increase of the number of protrusions, the content of K₂O in the glass substrate of the present embodiment is 0.1% or more, preferably 0.5% or more, more preferably 1% or more, still more preferably 2% or more, and particularly preferably 3% or more.

On the other hand, in the case where the content of K₂O exceeds 20%, the characteristics of the etched surface are deteriorated for example, the number of protrusions decreases. For this reason, the content of K₂O in the glass substrate of the present embodiment is 20% or less. The content of K₂O is preferably 15% or less, more preferably 12% or less, still more preferably 10% or less, particularly preferably 8% or less, and most preferably 6% or less.

In the case where the content of K₂O exceeds the content of Na₂O, the number of protrusions on the etched surface becomes insufficient. Therefore, the content of K₂O in the glass substrate of the present embodiment is preferably smaller than the content of Na₂O. For example, Na₂O content/K₂O content is preferably 1.1 or more, more preferably 1.5 or more, still more preferably 2 or more, particularly preferably 2.5 or more, and most preferably 3 or more.

The total of the contents of Na₂O, K₂O and Li₂O (Na₂O+K₂O+Li₂O) in the glass substrate of the present embodiment is preferably 30% or less, more preferably 28% or less, still more preferably 26% or less, and particularly preferably 25% or less. In the case where (Na₂O+K₂O+Li₂O) is 30% or less, decrease of RSm can be suppressed and washability can be improved.

TiO₂ is a component improving crushability of the chemically strengthened glass when chemically strengthening, and may be contained. In the case where TiO₂ is contained in the glass substrate of the present embodiment, the content is preferably 0.1% or more, more preferably 0.15% or more and still more preferably 0.2% or more.

On the other hand, in the case where the content of TiO₂ exceeds 1%, the glass is easy to be devitrified when melting, and the quality of the chemically strengthened glass may be deteriorated. The content of TiO₂ in the glass substrate of the present embodiment is 1% or less, preferably 0.8% or less, more preferably 0.5% or less, and still more preferably 0.25% or less.

ZrO₂ is a component increasing surface compressive stress by ion exchange, and has the effect of improving crushability of the glass. Therefore, ZrO₂ may be contained. In the case where ZrO₂ is contained in the glass substrate of the present embodiment, the content is preferably 0.5% or more and more preferably 1% or more.

On the other hand, in the case where the content of ZrO₂ exceeds 2%, the glass is easy to be devitrified when melting, and the quality may be deteriorated. The content of ZrO₂ in the glass substrate of the present embodiment is 2% or less, preferably 1.8% or less, more preferably 1.6% or less, still more preferably 1.4% or less, and particularly preferably 1.2% or less.

B₂O₃ is a component improving chipping resistance of the glass and furthermore improving meltability. B₂O₃ is not essential. In the case where B₂O₃ is contained in the glass substrate of the present embodiment, the content is preferably 0.5% or more, more preferably 1% or more and still more preferably 2% or more in order to improve meltability.

On the other hand, the content of B₂O₃ in the glass substrate of the present embodiment is 10% or less. In the case where the content is 10% or less, the generation of stria when melting is suppressed, and the quality of the glass is difficult to be deteriorated. The content of B₂O₃ is preferably 5% or less, more preferably 4% or less, still more preferably 3% or less, and particularly preferably 1% or less. To enhance acid resistance, B₂O₃ is not preferably contained.

P₂O₅ is a component improving ion exchange performance and chipping resistance. In the glass substrate of the present embodiment, P₂O₅ may not be contained. In the case where P₂O₅ is contained, the content is preferably 0.5% or more, more preferably 1% or more and still more preferably 2% or more.

On the other hand, in the case where the content of P₂O₅ in the glass substrate of the present embodiment is 4% or less, crushability and acid resistance of the chemically strengthened glass are improved. For this reason, the content of P₂O₅ is preferably 4% or less, more preferably 3% or less, still more preferably 2% or less and particularly preferably 1% or less. In order to enhance acid resistance, P₂O₅ is not preferably contained.

SrO is a component improving meltability of the glass for chemical strengthening, and is a component improving crushability of the chemically strengthened glass. Therefore, SrO may be contained. In the case where SrO is contained in the glass substrate of the present embodiment, the content is preferably 0.5% or more, more preferably 1% or more, still more preferably 2% or more, particularly preferably 3% or more, and most preferably 5% or more.

On the other hand, in the case where the content of SrO in the glass substrate of the present embodiment exceeds 20%, ion exchange performance is remarkably deteriorated. Therefore, the content is preferably 20% or less. The content of SrO is more preferably 14% or less, and is still more preferably stepwisely 10% or less, 8% or less, 6% or less, 3% or less, and 1% or less.

BaO is a component improving meltability of the glass for chemically strengthening, and is a component improving crushability of the chemically strengthened glass. Therefore, BaO may be contained. In the case where BaO is contained in the glass substrate of the present embodiment, the content is preferably 0.5% or more, more preferably 1% or more, still more preferably 2% or more, particularly preferably 3% or more, and most preferably 5% or more.

On the other hand, in the case where the content of BaO exceeds 15%, ion exchange performance is remarkably deteriorated. The content of BaO in the glass substrate of the present embodiment is preferably 15% or less, and is more preferably stepwisely 10% or less, 8% or less, 6% or less, 3% or less, and 1% or less.

ZnO is a component improving meltability of the glass and may be contained. In the case where ZnO is contained in the glass substrate of the present embodiment, the content is preferably 0.25% or more and more preferably 0.5% or more.

On the other hand, in the case where the content ZnO exceeds 10%, weatherability of the glass is remarkably deteriorated. The content of ZnO in the glass substrate of the present embodiment is preferably 10% or less, more preferably 7% or less, still more preferably 5% or less, particularly preferably 2% or less, and most preferably 1% or less.

La₂O₃ and Nb₂O₅ are components improving crushability of the glass and may be contained. In the case where these components are contained in the glass substrate of the present embodiment, the respective contents are preferably 0.5% or more, more preferably 1% or more, still more preferably 1.5% or more, particularly preferably 2% or more, and most preferably 2.5% or more.

On the other hand, in the case where the respective contents of La₂O₃ and Nb₂O₅ exceed 8%, respectively, the glass is easy to be devitrified when melting and the quality of the glass may be deteriorated. The respective contents of La₂O₃ and Nb₂O₅ in the glass substrate of the present embodiment are preferably 8% or less, more preferably 6% or less, still more preferably 5% or less, particularly preferably 4% or less, and most preferably 3% or less.

In the glass substrate of the present embodiment, Ta₂O₅ and Gd₂O₃ improve crushability of the glass and therefore may be contained in small amount. However, refractive index and reflectance are increased. Therefore, the respective contents of these components are preferably 1% or less and more preferably 0.5% or less. Still more preferably, these components are not contained.

In the case where the glass is colored to be used, a coloring component may be added in the range that achievement of the desired chemical strengthening characteristics is not impaired. Preferable examples of the coloring component include Co₃O₄, MnO₂, Fe₂O₃, NiO, CuO, Cr₂O₃, V₂O₅, Bi₂O₃, SeO₂, TiO₂, CeO₂, Er₂O₃ and Nd₂O₃.

In the glass substrate of the present embodiment, the total content of the coloring components is preferably 7% or less, in molar percentage on an oxide basis. In the case where the total content exceeds 7%, the glass is easy to be devitrified, and this not desirable. The content is preferably 5% or less, more preferably 3% or less and still more preferably 1% or less. In the case where visible light transmittance of the glass is prioritized, preferably these components are not substantially contained.

In the glass substrate of the present embodiment, SO₃, chlorides, fluorides and the like are appropriately contained as a fining agent when melting the glass. Preferably, As₂O₃ is not contained. In the case where Sb₂O₃ is contained, the content is preferably 0.3% or less and more preferably 0.1% or less. Most preferably, Sb₂O₃ is not contained.

Furthermore, the glass substrate of the present embodiment may have silver ions on the surface thereof, which can provide antibacterial activity.

The matrix composition of the glass substrate of the present embodiment is, for example, the following glass composition.

Glass composition containing 55 to 72% of SiO₂, 0.1 to 18% of Al₂O₃, 0 to 4% of B₂O₃, 0 to 1% of Y₂O₃, 2 to 12% of MgO, 0 to 10% of CaO, 0 to 11% of Li₂O, 3 to 20% of Na₂O, 0.1 to 10% of K₂O, 0 to 0.2% of TiO₂ and 0 to 1.5% of ZrO₂.

The glass substrate of the present embodiment has the etched surface on at least one of the main surfaces. In the present invention, the term “etched surface” means the surface that a certain amount of glass materials is removed by a chemical method (i e, acid etching) and specific surface texture/roughness is obtained. The etched surface of the glass substrate is characterized by the surface characteristics and optical characteristics thereof.

<Surface Characteristics>

The surface characteristics of the etched surface in the glass substrate of the present embodiment are described below.

(Shape Count)

The etched surface in the glass substrate of the present embodiment has the number of protrusions obtained by the following method being 400 or more. As for the method, a region of 285.12 μM×213.77 μm is measured with a laser microscope to obtain XYZ data of a surface shape. In a shape analysis of the XYZ data using the image processing software SPIP manufactured by Image Metrology, after leveling the entire surface, the number of protrusions when a threshold level of quantum detection is set to 50.0000 nm is obtained.

The number of protrusions is preferably 500 or more, more preferably 600 or more, still more preferably 700 or more, and particularly preferably 800 or more. Furthermore, the number of protrusions is preferably 2,000 or less, more preferably 1,600 or less, still more preferably 1,400 or less, and still further preferably 1,200 or less.

In the case where the number of protrusions is 400 or more, glare can be suppressed and visibility can be improved. In the case where the number of protrusions is 2,000 or less, decrease of RSm described hereinafter can be suppressed and washability can be improved.

(RSm)

The glass substrate of the present embodiment has a value of concavo-convex mean period (RSm) on the etched surface being preferably 30 or less, more preferably 28 or less, still more preferably 26 or less, and particularly preferably 25 or less. In the case where the RSm is 30 or less, glare Sₐ described hereinafter can be reduced and the glare can be suppressed.

The lower limit of the RSm is preferably 5 or more, more preferably 8 or more, still more preferably 12 or more, and particularly preferably 15 or more. In the case where the RSm is 5 or more, washability can be improved.

The concavo-convex mean period (RSm) generally means the average value of concavo-convex period in a roughness curve formed on a cross section of an object to be measured. The concavo-convex mean period (RSm) can be calculated from the calculation formula in accordance with JIS B0601 (2013).

(RΔa)

The glass substrate of the present embodiment has an arithmetic average inclination angle (RΔa) on the etched surface being preferably 1.50 or more, more preferably 1.60 or more, still more preferably 1.70 or more, and particularly preferably 1.80 or more under the condition of no cut-off value. In the case where the RΔa is 1.50 or more, glare can be suppressed and visibility can be improved.

In the glass substrate of the present embodiment, the RΔa is preferably 15 or less, more preferably 12 or less and still more preferably 10 or less. In the case where the RΔa is 15 or less, washability can be improved.

The arithmetic average inclination angle (RΔa) means a value obtained by sectioning a profile curve at a regular interval ΔX in a lateral direction, obtaining an absolute value of inclination (angle) of a line segment connecting a starting point and an end point of the profile curve in each section, and averaging the obtained values. The RΔa is measured and calculated by using a laser microscope. Measurement point is plural points, and is at least 10 points and preferably 12 points or more.

As for the measurement procedures, a line roughness analysis is selected and the analysis is conducted at an arbitrary position. Data analysis may be a horizontal direction to the measurement data and may be a vertical direction thereto. The data analysis is conducted without a cut-off value Xs, without a phase compensation high-pass filter Xc and without a phase compensation low-pass filter Xf.

(Ra)

The glass substrate of the present embodiment has an arithmetic average roughness (Ra) on the etched surface being preferably 0.02 or more, more preferably 0.04 or more and still more preferably 0.06 or more.

On the other hand, in the glass substrate of the present embodiment, the Ra is preferably 0.50 or less, more preferably 0.40 or less and still more preferably 0.30 or less.

In the glass substrate of the present embodiment, in the case where the Ra is 0.02 or more, glare can be reduced. In the case where the Ra is 0.50 or less, washability can be improved. The Ra can be calculated by the calculation formula in accordance with JIS B0601 (2013).

(Rz)

The glass substrate of the present embodiment has a maximum height (Rz) of a surface roughness on the etched surface being preferably 0.10 or more, more preferably 0.20 or more and still more preferably 0.30 or more.

Furthermore, in the glass substrate of the present embodiment, the Rz is preferably 2.50 or less, more preferably 2.40 or less and still more preferably 2.30 or less.

In the case where the Rz is 0.10 or more, glare can be reduced. In the case where the Rz is 2.50 or less, washability can be improved. The Rz can be calculated by the calculation formula in accordance with JIS B0601 (2013).

<Optical Characteristics>

(Haze Rate)

The glass substrate of the present embodiment has a haze rate of the transmitted light of preferably 0.2% or more, more preferably 0.5% or more and still more preferably 1% or more in a visible light region measured in accordance with JIS K7136 (2000) on the etched surface. Furthermore, the haze rate is preferably 75% or less, more preferably 70% or less and sill more preferably 65% or less. In the case where the haze rate is in the above range, the reflection of light can be significantly suppressed.

(Glare Sₐ)

In the present description, glare Sₐ measured by the following procedures is used as an index of the glare. When light (image) from display image is scattered by a glass plate surface when the light is transmitted through the glass plate and the scattered lights interfere with each other, brightness unevenness is caused. The glare Sₐ shows how much the brightness unevenness is detected, and it is confirmed that the glare Sₐ shows good correlation with the judgement result of the glare by visual inspection of an observer. For example, the glass plate having a large glare Sₐ has a tendency that the glare is remarkable, while the glass plate having a small glare Sₐ has a tendency that the glare is suppressed.

The glass substrate of the present embodiment has the glare Sₐ measured by the following method on the etched surface being preferably 8 or less, more preferably 7 or less, still more preferably 6 or less, and particularly preferably 5 or less.

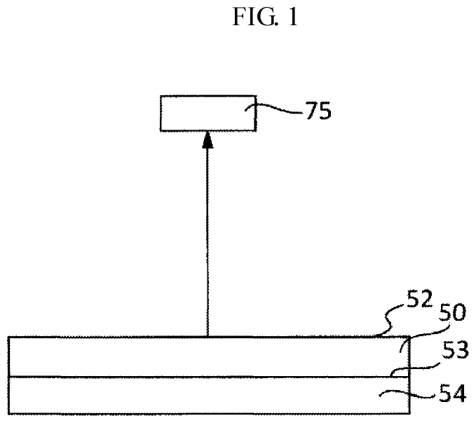

The measurement method of the glare Sₐ is explained with reference to FIG. 1. In measuring the glare Sₐ, a display device 54 (iPad (registered trademark)-Air 2; resolution 264 ppi) is prepared. A cover for breakage prevention and the like may be provided on the display surface side of the display device.

Next, a sample to be measured, that is, a glass substrate 50 is placed on the display surface side of the display device. In the case where a first main surface 52 that is one main surface of the glass substrate 50 includes an etched surface, the glass substrate 50 is placed on the display surface side of the display device such that the first main surface 52 is the side opposite the display device 54 (i.e., surface luminance measuring instrument 75 side). In other words, a second main surface 53 that is the other main surface is arranged on the display device 54.

Next, the degree of glare of the glass substrate 50 is image-analyzed by using an analyzer (SMS-1000, manufactured by Display-Metrology & Systems (DM&S)) in a state of turning on the display device and displaying an image. In this manner, the glare Sₐ indicated as Sparkle value is obtained.

In measuring, an image of single green constituted of RGB (0, 255, 0) is preferably displayed on the entire display surface of the display device 54. This is because the influence of, for example, the difference of appearance due to the difference of display color is minimized as possible. The distance d between the tip of an imaging camera lens of the device and a transparent substrate having an antiglare function is set to 568 mm. In this measurement, the pixel ratio value (value indicating how many times the pitch of one pixel of the display device corresponds to the pixel pitch of the imaging camera) is 2.45. The camera lens is 23FM50SP lens having a focal length of 50 mm and an aperture is 16. Evaluation region ROI is set to 200×200. The measurement is conducted by a difference image method (DIM), 0 is input as the pixel ratio value, and the glare Sₐ is obtained. The same measurement can be conducted by a single image method (SIM). However, the absolute value of the glare Sₐ obtained in this case differs, and must be distinguished.

It is confirmed that the glare Sₐ shows good correlation with the judgement result of the glare by visual inspection of an observer. For example, a transparent substrate having a large glare Sₐ has a tendency that the glare is remarkable, while a transparent substrate having a small glare Sₐ has a tendency that the glare is suppressed.

(G60)

The glass substrate of the present embodiment has mirror surface glossiness GS) (60° (hereinafter abbreviated as G60) of 60° mirror surface gloss defined in JIS Z8741 (1997) on the etched surface being preferably 10 or more, more preferably 15 or more and still more preferably 20 or more. Furthermore, the G60 is preferably 140 or less, more preferably 135 or less and still more preferably 130 or less. Furthermore, the G60 is preferably 10 more and 140 or less, more preferably 15 or more and 135 or less, and still more preferably 20 or more and 130 or less. In the case where the G60 is in the above ranges, reflection of ambient light is suppressed.

(Reflection Image Diffusiveness Index Value R)

In the present description, the reflection image diffusiveness index value R measured by the following procedures is used as the index of antiglareness. The reflection image diffusiveness (reflection image diffusiveness index value) indicates to what extent the reflection image of an object (for example, illumination) placed around the glass plate coincides with the original object, and it is confirmed that the reflection image diffusiveness (reflection image diffusiveness index value) shows good correlation with the judgement result of the antiglareness by visual inspection of an observer. For example, the glass plate showing a small value (close to 0) of the reflection image diffusiveness index value R has poor antiglareness, while the glass plate showing a large value (the closer to 1, the larger) of the reflection image diffusiveness index value R has good antiglareness.

The glass substrate of the present embodiment has the reflection image diffusiveness index value R on the etched surface being preferably 0.01 or more, more preferably 0.05 or more and still more preferably 0.1 or more. In the case where the reflection image diffusiveness index value R is in the above ranges, sufficient antiglareness can be obtained.

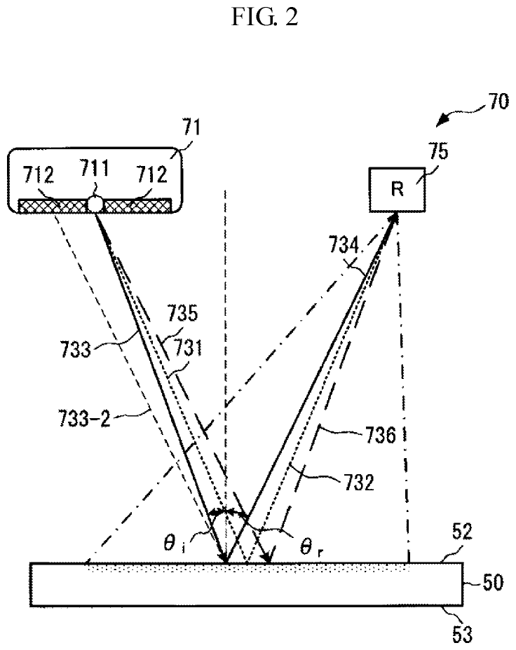

The measurement method of the reflection image diffusiveness index value R of the glass substrate 50 is explained with reference to FIG. 2. FIG. 2 schematically illustrates one example of a measurement apparatus used in measuring the reflection image diffusiveness index value R.

As illustrated in FIG. 2, a measurement apparatus 70 has a linear light source device 71 and a surface brightness measuring instrument 75, and a sample to be measured, that is, a glass substrate 50 having an antiglare function (transparent substrate (or antiglare-processed transparent substrate having an antiglare function) 50) is arranged in the measuring apparatus 70. The linear light source device 71 includes a light source 711 and a black flat plate 712, and the light source 711 is provided on a slit-shaped opening of the black flat plate 712. The glass substrate 50 has a first main surface 52 having an etched surface and a second main surface 53. The linear light source device 71 is arranged facing the glass substrate 50 and along in a vertical direction to paper in FIG. 2. The surface brightness measuring instrument 75 is arranged on a plane vertically crossing the linear light source device 71 at the center of a paper vertical direction of the linear light source device 71. The focus of the surface brightness measuring instrument 75 is made coincident with an image of the linear light source device 71 reflected on the glass substrate 50. In other words, the focused surface of the image is made coincident with the black flat plate 712. When attention is paid to the light ray that an incident angle θi equals to a reflection angle θr among lights emitted from the linear light source device 71, reflecting on the glass substrate 50 and entering the surface brightness measuring instrument 75 (hereinafter referred to as first incident light 731, first reflection light 732), θi=θr=5.7° is achieved.

The glass substrate 50 is placed such that the first main surface 52 is on the linear light source device 71 and surface brightness measuring instrument 75 side. A black flat board is placed on the second main surface 53 side of the glass substrate 50. Therefore, the light detected by the surface brightness measuring instrument 75 is reflected light reflected on the glass substrate 50.

The measurement method is described below. For example, When attention is paid to light rays 733 and 734 in which the difference between the incident angle θi and the reflection angle θr is θr−θi=0.5°, the light ray 734 indicates the component scattered on the glass substrate 50 in a direction deviating 0.5° from regular reflection. In the surface brightness measuring instrument 75, the light ray from this direction is observed as an image of the portion that the black flat plate 712 intersects with virtual incident light 733-2 (light ray entering from an incident angle equal to the reflection angle of the light ray 734). In other words, in the case where the surface brightness is obtained by the surface brightness measuring instrument 75, an image that the light scattered on the first main surface 52 of the glass substrate 50 has spread to the right and left centering bright line corresponding to the regular reflection of the linear light source device 71 is obtained. Brightness section profile in a direction vertical to this bright line is extracted. To increase measurement accuracy, data in a direction parallel to the bright line may be integrated.

The brightness of the first reflection light 732 regularly reflected among lights entering the first main surface 52 of the glass substrate 50 is denoted as R₁. The incident angle θi of the first incident light 731 is 5.7° and the reflection angle θr of the first reflection light 732 is 5.7°. The angle that light ray changes by the reflection on the glass substrate 50 (transparent substrate 50) is written as θr−θi and is 0°. Because an error is contained in the enforcement, θr−θi is a range of 0°±0.1°.

The brightness of the light rays 733 and 734 in which the difference between the incident angle θi and the reflection angle θr is θr−Oi=0.5° is denoted as R₂. The light ray indicates the component scattered on the glass substrate 50 (transparent substrate 50) in a direction deviating 0.5° from regular reflection. Actually, because an error is contained, the difference θr−θi is 0.5°±0.1°.

Similarly, the brightness of light rays 735 and 736 in which θr−θi is −0.5° is denoted as R₃. The light ray indicates the component scattered on the glass substrate 50 (transparent substrate 50) in a direction deviating −0.5° from regular reflection. Actually, because an error is contained, the difference θr−θi is −0.5°±0.1°.

By using the brightness of R₁, R₂ and R₃ obtained, the reflection image diffusiveness index value R of the glass substrate 50 is calculated by the following formula (1).

Reflection image diffusiveness index value R=(R₂+R₃)/(2×R₁) (1)

It is confirmed that the reflection image diffusiveness index value R shows good correlation with judgement result of the antiglareness by visual inspection of an observer. For example, the glass substrate 50 showing a small value (close to 0) of the reflection image diffusiveness index value R has poor antiglareness, while the glass substrate 50 showing a large value (the closer to 1, the larger) of the reflection image diffusiveness index value R has good antiglareness.

The measurement can be conducted by using the instrument SMS-1000, manufactured by DM&S. In the case where this instrument is used, C1614A lens having a focal length of 16 mm is used with aperture 5.6 as the camera lens. The distance of from the first main surface 52 of the transparent substrate 50 constituting the glass substrate 50 to the camera lens is set to about 300 mm, and the imaging scale is set to a range of 0.0276 to 0.0278. The slit-shaped opening formed by the black flat plate 712 of the linear light source device 71 is set to 101 mm×1 mm.

<Manufacturing Method>

The method for manufacturing the glass substrate of the present embodiment includes a step of subjecting a glass substrate having the matrix composition described above to a frost treatment to form an etched surface. The frost treatment can be carried out by, for example, dipping a glass substrate as an object to be treated in a mixed solution of hydrofluoric acid and ammonium fluoride to chemically surface treat the dipped surface.

Examples of the surface treatment to be carried out for the above purpose include a method of applying the frost treatment to a first main surface of the glass substrate. The frost treatment can be carried out by, for example, dipping the first main surface of the glass substrate as an object to be treated in a mixed solution of hydrofluoric acid and ammonium fluoride, a mixed solution of hydrofluoric acid and potassium fluoride or the like to chemically surface treat the dipped surface. In particular, in the method of applying the frost treatment of chemically surface-treating by using a liquid chemical such as hydrofluoric acid, microcracks are hardly formed on the treated surface and mechanical strength is hardly deteriorated. Therefore, this method is preferred.

After forming unevenness in this manner, the glass surface is preferably chemically etched in order to adjust the surface shape. The chemical etching can remove cracks formed by sandblasting or the like and can effectively suppress glare.

Examples of the etching method include a method of dipping the glass substrate as an object to be treated in a treating solution comprising hydrogen fluoride as a main component. Examples of the components other than hydrogen fluoride include hydrochloric acid, nitric acid, citric acid, and sulfuric acid. Of these, hydrochloric acid and sulfuric acid are particularly preferred. In the case of containing these acids, alkali components contained in the glass are reacted with hydrogen fluoride to suppress the occurrence of a local precipitation reaction, and as a result, etching can be uniformly proceeded in the plane.

The glass plate is a glass plate formed by a float process, a downdraw process or the like. Furthermore, the glass plate may be not only a flat-shaped glass plate, but a glass plate having a curved surface. The thickness of the glass plate is not particularly limited, and for example, a glass plate having a thickness of 10 mm or less can be used. Absorption of light is suppressed low as the thickness is small, which is preferable for the intended use where an improvement of transmittance is aimed.

The glass substrate may be a strengthened glass plate. The strengthened glass plate is a glass plate having been subjected to a strengthening treatment. The strengthening treatment improves strength of the glass and, for example, makes it possible to reduce the plate thickness while maintaining strength. A treatment of forming a compressive stress layer on the glass plate surface is generally known as the strengthening treatment. Examples of the means for forming the compressive stress layer on the glass plate surface include an air cooling strengthening method (physical strengthening method) and a chemical strengthening method.

The plate thickness of the glass plate to be subjected to a chemical strengthening treatment is preferably 0.1 to 3.0 mm and particularly preferably 0.3 to 1.5 mm. The physical strengthening treatment and chemical strengthening treatment of the glass may be conducted before the formation of the etched surface on the main surface of the glass plate and may be conducted after the formation.

### EXAMPLES

The present invention is described below with reference to specific examples, but it should be understood that the present invention is not limited to these examples.

### Preparation of Sample

### Examples 1 to 14

A glass plate of the present embodiment was prepared by the following procedures. Glass plates (size: 300 mm×300 mm, thickness 1.0 mm) that were not strengthened and had the compositions shown in Table 1 were used as the glass substrate.

An acid-resistant protective film was bonded to the main surface on which an etched surface was not to be formed, of the glass plate. Then, the frost treatment was conducted in the following procedures, to form an etched surface on the glass plate.

The glass plate was dipped in a hydrofluoric acid aqueous solution to remove stains adhered to the main surface to which the protective film was not bonded, of the glass plate, and the thickness of the glass plate was adjusted as pre-processing. Then, the glass plate was dipped in a mixed solution of hydrofluoric acid and ammonium fluoride to perform a frost treatment on the main surface to which the protective film was not bonded, of the glass plate, to thereby forming a large number of fine depressions on the main surface of the glass plate.

<Evaluation Methods>

Characteristics of the glass plates prepared in Examples 1 to 14 above were evaluated by the following methods. The results are shown in Table 1. Examples 1 to 11 are Invention Examples and Examples 12 to 14 are Comparative Examples. In Table 1, “−” means “unmeasured”.

(Shape Count)

Surface shape of the main surface having the etched surface of the glass plate was measured with a laser microscope (trade name VK-X250, manufactured by Keyence) on a region of 285.12 μm×213.77 μm that was observed with 50× objective lens, to thereby obtain XYZ data. In a shape analysis of the XYZ data using the image processing software SPIP 6.4.3 manufactured by Image Metrology, after leveling the entire surface, the number of protrusions when a threshold level of quantum detection was set to 50.0000 nm was measured.

(RSm, RΔa, Ra, Rz)

Surface shape of the main surface having the etched surface of the glass plate was analyzed by using 50× objective lens with a laser microscope (trade name VK-X250, manufactured by Keyence). RSm, RΔa, Ra, and Rz were obtained by an analysis using a multifile analysis application made by Keyence. The measurement of Ra, RSm and Rz was calculated by the calculation formula in accordance with JIS B0601 (2013). The data analysis was conducted without cut-off value λs, without phase compensation high-pass filter λc and without phase compensation low-pass filter λf.

(Haze Rate)

The haze rate (%) on the etched surface of the glass plate was measured. The measurement of the haze rate was conducted in accordance with JIS K7136 (2000) by using a haze meter (trade name: HZ-V3, manufactured by Suga Test Instruments Co., Ltd.).

(Reflection Image Diffusiveness Index Value R)

A glass plate (100 mm×100 mm×1.3 mm in thickness) was placed such that a first main surface side faced upward, and brightness of the reflected light obtained by emitting slit-shaped light having a width of 101 mm from above was measured by SMS-1000, manufactured by DM&S. On this occasion, a matte black board was placed on a second main surface side in order to eliminate reflection (back reflection) from the second main surface. The camera lens was C1614A lens having a focal length of 16 mm and was used with an aperture of 5.6. The distance of from the first main surface of the glass plate to the camera lens was set to 300 mm and the imaging scale was set to a range of 0.0276 to 0.0278.

When a direction parallel to a thickness direction of the glass plat was angle 4=0°, the light was radiated from the angle of ϕ=5.7°±0.1°, and an angle of ϕ=−5.7° when totally reflecting was set as the standard (angle α=0°). The average value of brightness of reflected lights in a range of angle α=0°±0.1° was denoted as R₁, the average value of brightness of reflected lights in a range of angle α=0.5°±0.1° was denoted as R₂ and the average value of brightness of reflected lights in a range of angle α=−0.5°±0.1° was denoted as R₃. The value calculated by the following formula (1) was taken as the reflection image diffusiveness index value R.

Reflection image diffusiveness index value R=(R₂+R₃)/(2×R₁) (1)

(Glare Sₐ)

A glass plate (100 mm×100 mm×1.6 mm in thickness) was placed on the display surface side of a display device having resolution of 264 ppi (iPad (registered trademark)-Air, manufactured by Apple, Inc.) such that the second main surface of the glass plate was in contact with the display surface side. In the state where an image of single green constituted of RGB (0, 255, 0) was displayed on the display device, Sparkle value was obtained by an image analysis using SMS-1000 manufactured by DM&S arranged above the glass plate, and was taken as the glare Sₐ. The distance d between a fixed image sensor and the glass plate was set to 540 mm, the camera lens used was 23FM50SP lens having a focal length of 50 mm, and lens aperture was 16.

(G60)

The mirror surface glossiness GS (60°) of 60° mirror surface gloss on the etched surface of the glass plate was obtained in accordance with JIS Z8741 (1997). The measurement was conducted by using Rhopoint IQ-S, manufactured by Konica Minolta.

TABLE 1

| (mol %) | Ex. 1 | Ex. 2 | Ex. 3 | Ex. 4 | Ex. 5 | Ex. 6 | Ex. 7 | Ex. 8 | Ex, 9 | Ex. 10 | Ex. 11 | Ex. 12 | Ex. 13 | Ex. 14 |
|---|---|---|---|---|---|---|---|---|---|---|---|---|---|---|
| SiO₂ | 55 | 60.4 | 56 | 58 | 60 | 71.2 | 69.2 | 64.4 | 67.1 | 66.2 | 64.5 | 68 | 72.4 | 60 |
| Al₂O₃ | 18 | 10.5 | 15 | 10 | 10 | 0.39 | 7.4 | 8 | 13.1 | 11.2 | 10.5 | 10 | 0 | 10 |
| B₂O₃ | 0 | 0 | 0 | 0 | 0 | 0 | 0 | 0 | 3.6 | 0 | 0 | 0 | 0 | 0 |
| Y₂O₃ | 0 | 0 | 0 | 0 | 0 | 0 | 0 | 0 | 0 | 0.5 | 0 | 0 | 0 | 0 |
| MgO | 2 | 8.4 | 11.3 | 12 | 11 | 6 | 6.9 | 10.5 | 2.3 | 3.1 | 8.3 | 8 | 10.5 | 0 |
| CaO | 0 | 0 | 0 | 0 | 0 | 9.44 | 1.2 | 0.1 | 0 | 0.2 | 0 | 0 | 0.01 | 0 |
| Li₂O | 0 | 0 | 0 | 0 | 0 | 0 | 7.9 | 0 | 0 | 10.4 | 0 | 0 | 0 | 0 |
| Na₂O | 20 | 12 | 9.1 | 10 | 3 | 12.8 | 5.2 | 12.5 | 13.7 | 5.6 | 16 | 14 | 12.5 | 20 |
| K₂O | 4 | 7.7 | 8.1 | 9 | 15 | 0.09 | 1.0 | 4 | 0.1 | 1.5 | 0.6 | 0 | 4 | 10 |
| TiO₂ | 0 | 0 | 0 | 0 | 0 | 0 | 0.1 | 0 | 0 | 0.115 | 0.04 | 0 | 0 | 0 |
| ZrO₂ | 1 | 1 | 0.5 | 1 | 1 | 0 | 1.0 | 0.5 | 0 | 1.3 | 0.15 | 0 | 0.5 | 0 |
| Shape count | 1183 | 1433 | 658 | 845 | 1049 | 608 | 759 | 1097 | 862 | 1043 | 526 | 278 | 59 | 3500 |
| Haze rate | 3.68 | 0.73 | 0.39 | 0.29 | 0.76 | 4.74 | 65.38 | 48.99 | 72.59 | 58.46 | 2.05 | 1.24 | 1.20 | — |
| (%) | | | | | | | | | | | | | | |
| Reflection | 0.04 | 0.01 | 0.03 | 0.01 | 0.04 | 0.01 | 1.00 | 0.34 | 0.98 | 0.99 | 0.05 | 0.08 | 0.37 | — |
| image | | | | | | | | | | | | | | |
| diffusiveness | | | | | | | | | | | | | | |
| index value | | | | | | | | | | | | | | |
| R | | | | | | | | | | | | | | |
| Glare Sₐ | 4.4 | 3.9 | 5.9 | 2.8 | 6.5 | 0.9 | 3.2 | 4.8 | 2.5 | 4.2 | 5.4 | 9.02 | 17.95 | — |
| G60 | 117.4 | 127.9 | 127.9 | 127.8 | 127.7 | 125.1 | 15.1 | 24.3 | 10.1 | 12.5 | 126.3 | 125.90 | 106.50 | — |
| Ra | 0.04 | 0.02 | 0.02 | 0.02 | 0.03 | 0.04 | 0.38 | 0.20 | 0.37 | 0.28 | 0.04 | 0.05 | 0.11 | — |
| Rz | 0.43 | 0.14 | 0.15 | 0.11 | 0.16 | 0.29 | 2.15 | 1.58 | 2.11 | 1.64 | 0.22 | 0.25 | 0.51 | — |
| RSm | 25.60 | 17.58 | 28.08 | 19.62 | 25.32 | 20.93 | 18.06 | 25.77 | 18.38 | 26.43 | 24.60 | 27.41 | 42.93 | 8.5 |
| RΔa | 2.81 | 2.13 | 1.63 | 1.86 | 2.35 | 2.89 | 12.76 | 10.00 | 13.27 | 11.64 | 1.77 | 1.62 | 1.64 | — |

As shown in Table 1, Examples 1 to 11 that were Inventive Examples of the present invention had the matrix composition of the glass in the specified range. As result, the shape count, glare Sₐ and RSm were good, the glare was effectively suppressed and washability was excellent.

On the other hand, Example 12 that was a Comparative Example had the content of K₂O falling outside the specified range, the value of shape count was outside the specified range and the glare Sₐ was not preferred. Furthermore, the RSm was slightly high as compared with Inventive Examples.

Example 13 that was a Comparative Example had the content of Al₂O₃ falling outside the specified range, the value of shape count was outside the specified range and the glare Sₐ and RSm were not preferred.

Example 14 that was a Comparative Example had the total content of Na₂O, K₂O and Li₂O being 30% or more and the value of shape count was outside the specified range. In addition, RSm was low as compared with Inventive Examples, and this suggested that washability was poor.

Various embodiments are described above by reference to the drawings, but it goes without saying that the present invention is not limited to those examples. It is apparent that one skilled in the art can reach various changes and modifications in the scope described in the claims, and it is understood that those changes and modifications naturally belong to the technical scope of the present invention. Additionally, each constituent element in the above embodiments may be optionally combined within the scope that does not deviate the gist of the present invention.

This application is based on Japanese Patent Application No. 2020-013695 filed on Jan. 30, 2020, the contents of which are incorporated herein by reference.

### REFERENCE SIGNS LIST

50: Glass substrate (transparent substrate)
52: First main surface
53: Second main surface
54: Display device
70: Measuring apparatus
71: Linear light source device
75: Surface brightness measuring instrument
711: Light source
712: Black flat plate
731: First incident light
732: First reflection light
733, 734, 735, 736: Light ray
733-2: Virtual incident light
θi: Incident angle
θr: Reflection angle

1. A glass substrate,
having a matrix composition comprising, in molar percentage on an oxide basis:
SiO₂: 50 to 75%,
Al₂O₃: 0.1 to 25%,
B₂O₃: 0 to 10%,
Y₂O₃: 0 to 5%,
MgO: 0 to 20%,
CaO: 0 to 15%,
Li₂O: 0 to 15%,
Na₂O: 1 to 25%,
K₂O: 0.1 to 20%,
TiO₂: 0 to 1%, and
ZrO₂: 0 to 2%, and
comprising an etched surface having the number of protrusions obtained by the following method of 400 or more and 2,000 or less on at least one of main surfaces:
method: a region of 285.12 μm×213.77 μm is measured with a laser microscope to obtain XYZ data of a surface shape, and in a shape analysis of the XYZ data using an image processing software SPIP manufactured by Image Metrology, after leveling the entire surface, the number of protrusions when a threshold level of particle detection is set to 50.0000 nm is obtained.

2. The glass substrate according to claim 1, wherein the etched surface has a value of concavo-convex mean period RSm of 30 μm or less.

3. The glass substrate according to claim 1, wherein the etched surface has an arithmetic average inclination angle RΔa of 1.50° or more under the condition of no cut-off value.

4. The glass substrate according to claim 1, wherein the etched surface has a haze rate of transmitted light of 0.2 to 75% as measured by the method in accordance with JIS K7136 (2000).

5. The glass substrate according to claim 1, wherein the etched surface has a glare Sₐ of 8 or less as quantified by the following method:
method: the glass substrate is placed on a display surface of a display device having a definition of 264 ppi such that the etched surface is into contact with the display surface, and in a state where an image of single green constituted of RGB (0, 255, 0) is displayed on the display device, a Sparkle value is obtained by an image analysis using SMS-1000 manufactured by DM&S arranged above the glass substrate and denoted as the glare Sₐ, in which a distance d between a fixed image sensor and the glass substrate is set to 568 mm, a camera lens used is 23FM50SP lens having a focal length of 50 mm, and lens aperture is 16, and in which the measurement is conducted by a difference image method (DIM), 0 is input as a pixel ratio value, and the glare Sₐ is obtained.

6. The glass substrate according to claim 1, wherein the matrix composition satisfies that the total content of Na₂O, K₂O and Li₂O is less than 30% in molar percentage on an oxide basis.

7. A display device comprising the glass substrate described in claim 1.

8. A method for producing a glass substrate comprising an etched surface having the number of protrusions obtained by the following method of 400 or more and 2,000 or less on at least one of the main surfaces, the method comprising a step of subjecting a glass substrate comprising, in molar percentage on an oxide basis:
SiO₂: 50 to 75%,
Al₂O₃: 0.1 to 25%,
B₂O₃: 0 to 10%,
Y₂O₃: 0 to 5%,
MgO: 0 to 20%,
CaO: 0 to 15%,
Li₂O: 0 to 15%,
Na₂O: 1 to 25%,
K₂O: 0.1 to 20%,
TiO₂: 0 to 1%, and
ZrO₂: 0 to 2%;
to a frost treatment:
method: a region of 285.12 μm×213.77 μm is measured with a laser microscope to obtain XYZ data of a surface shape, and in a shape analysis of the XYZ data using an image processing software SPIP manufactured by Image Metrology, after leveling the entire surface, the number of protrusions when a threshold level of particle detection is set to 50.0000 nm is obtained.
